(19) United States
(12) Patent Application Publication
(10) Pub. No.: US 2015/0280510 A1
(43) Pub. Date: Oct. 1, 2015

(54) GROOVED WEDGE FOR ROTOR

(71) Applicants: Dmitry Yurevich SEMENOV, Moscow (RU); Oleg Aleksandrovich MOSKVITIN, Moscow (RU); Yury Danilovich VINITZKY, Moscow (RU); GENERAL ELECTRIC COMPANY, Schenectady, NY (US)

(72) Inventors: Dmitry Yurevich Semenov, Moscow (RU); Oleg Aleksandrovich Moskvitin, Moscow (RU); Yury Danilovich Vinitsky, Moscow (RU)

(73) Assignee: General Electric Company, Schenectady, NY (US)

(21) Appl. No.: 13/823,656

(22) PCT Filed: Oct. 30, 2012
(86) PCT No.: PCT/IB2012/002951

§ 371 Date: Mar. 14, 2013

(51) Int. Cl. H02K 3/487

(52) U.S. Cl. CPC H02K 3/487

(57) ABSTRACT

A grooved wedge for a rotor is provided. In one aspect, slot wedges are mounted in radially-arranged slots to cap field coils disposed therein. Each wedge has a wedge dovetail that engages with a dovetail formed in a wall of each slot. The wedge dovetail has a groove formed near a contacting surface that interfaces with the slot dovetail. The groove extends axially from a first wedge end face to a second wedge end face opposite therefrom.

### BACKGROUND OF THE INVENTION

The present invention relates generally to rotors used with dynamoelectric machines, and more particularly, to wedges used in capping field coils disposed in slots of a rotor.

Conventional dynamoelectric machines, such as generators used with ins and steam turbines, employ forged rotors of magnetic material into which radial slots are machined for receiving conductive turns of field windings. The turns of field windings are interconnected to produce a desired magnetic flux pattern. Typically, the turns of field windings in each slot are disposed between creepage blocks located at a top portion (radially outer) and a bottom portion (radially inner) of the slot, between slot armor disposed at the sides of the slot. Slot wedges are mounted on the top portions of each slot to maintain the turns of field windings in the slots and to resist radially outward forces exerted on the windings when the rotor is operational.

Over a long term of generator operation, rotor teeth, which are the “finger” portions of the rotor that are located between the slots, have the potential for cracking at surfaces where the teeth abut against the slot wedges. In particular, cracks can occur at surfaces of a dovetail portion of the teeth that engage with a dovetail portion of a slot wedge. Typically, crack indications are located at a wedge end face and go radially, and/or along wedge loading surfaces such as locations where the dovetail portion of a rotor tooth abuts against the dovetail portion of a slot wedge. Repairing cracks that form in rotor teeth can require a labor intensive machining operation that may require the rotor to be taken offline for a period of time. Taking a rotor offline can be expensive and result in lost power generation production.

### BRIEF DESCRIPTION OF THE INVENTION

Therefore, it is desirable to minimize or eliminate, in most cases, the occurrence of cracks from arising at surfaces where rotor teeth abut against the slot wedges.

In one aspect of the present invention, a rotor is provided. The rotor comprises a plurality of radially-arranged slots each having a dovetail formed therein. A plurality of field coils are disposed in each of the slots. A plurality of slot wedges each mounted in one of the slots caps the field coils disposed therein. Each slot wedge has a groove formed near a contacting surface that interfaces with a dovetail of one of the slots. The groove extends axially from a first wedge end face to a second wedge end face opposite therefrom.

In another aspect of the present invention, a generator rotor is provided. In this aspect of the present invention, the generator rotor comprises a plurality of radially-arranged generator slots. Each generator slot has a dovetail-shaped portion including an entry surface, an inwardly tapered surface, and an intermediate surface. A plurality of field coil turns are disposed in each of the generator slots. A plurality of slot wedges each mounted in one of the generator slots caps the field coil turns disposed therein. Each side of each slot wedge has a wedge dovetail-shaped portion that engages with a dovetail-shaped portion of one of the slots. The wedge dovetail-shaped portion includes a slot wedge upper surface, a slot wedge outwardly extending surface, and a slot wedge lower surface. The slot wedge lower surface has a groove extending axially throughout an entire length of the slot wedge from a first wedge end face to a second wedge end face. The slot wedge upper surface engages with the entry surface, the slot wedge outwardly extending surface engages with the inwardly tapered surface and the slot wedge lower surface engages with the intermediate surface.

In a third aspect of the present invention, a dynamoelectric machine comprising a rotor is disclosed. In this aspect of the present invention, the rotor includes a plurality of radially-arranged slots. Each slot has a dovetail-shaped portion including an entry surface, an inwardly tapered surface extending from the entry surface, and an intermediate surface extending from the inwardly tapered surface. A plurality of coils are disposed in each of the slots. A plurality of slot wedges each mounted in one of the slots caps the coils disposed therein. Each side of each slot wedge has a wedge dovetail-shaped portion that engages with a slot dovetail-shaped portion of one of the slots. The wedge dovetail-shaped portion includes a slot wedge upper surface, a slot wedge lower surface, and a slot wedge outwardly extending surface joining the slot wedge upper surface with the slot wedge lower surface. The slot wedge lower surface has a groove extending axially throughout an entire length of the slot wedge from a first wedge end face to a second wedge end face. The slot wedge upper surface engages with the entry surface, the slot wedge outwardly extending surface engages with the inwardly tapered surface, and the slot wedge lower surface engages with the intermediate surface.

### BRIEF DESCRIPTION OF THE DRAWINGS

FIG. 1 is a side-elevation view of a rotor used for a dynamoelectric machine;

FIG. 2 is a partial cross-sectional view of the rotor body of the rotor taken along lines 2-2 of FIG. 1 showing radially-arranged slots with radially-arranged rotor teeth separating the slots;

FIG. 3 is a cross-sectional view through a slot of a rotor such as those depicted in FIG. 2, that shows contents disposed therein; and

FIG. 4 is a schematic of an enlarged, partial cross-sectional, perspective view showing a slot wedge used to cap contents disposed in a slot depicted in FIG. 3 in relation to a rotor tooth as depicted in FIG. 2, according to one embodiment of the present invention.

### DETAILED DESCRIPTION OF THE INVENTION

Various embodiments of the present invention are directed to providing a slot wedge used to cap field coils disposed in radially-arranged slots of a rotor body of a dynamoelectric machine such as a generator. In these embodiments, a groove extends axially throughout an entire length of the wedge from a first wedge end face to a second wedge end face opposite therefrom. In one embodiment, the groove is provided in a wedge dovetail portion of a slot wedge on a contacting surface that interfaces with a dovetail portion formed in each slot of the radially-arranged slots.

Technical effects of the various embodiments of the present invention include minimizing or eliminating, in most cases, the occurrence of cracks from arising at high stress concentration areas such as surfaces where rotor teeth abut against the slot wedges. Other technical effects associated with providing a slot wedge with a groove that extends axially throughout the entire length of the wedge is that it enables the use of high strength material to be used for the wedge. Typically, the use of high strength material for a wedge has been prohibitive because such materials exacerbate stress concentrations at edges of contact at the interface between the wedge dovetail portion of a slot wedge and a dovetail portion of a slot. The use of high strength material for a wedge enables manufacture of smaller wedges, which can result in more space in the slots to dispose field coils. Having more space in the slots enables generator rotors to be manufactured with slots having increased sub-slot depths. Slots with increased sub-slot depths can translate to improved ventilation and increased generator output power. In particular, if the additional space is used to dispose more coils in the slots, then the losses will be less which corresponds to less ventilation challenges and increased generator output power. Another technical effect associated with providing a slot wedge with a groove that extends axially throughout the entire length of the wedge is that it enables a reduction of total slot depth. This allows an increase in spindle diameter, which can result in a reduction in risks associated with rotor high cycle fatigue and rotor lateral dynamics.

Although the various embodiments of the present invention are directed to generator rotors used with steam and gas turbines, the embodiments of the present invention are suitable for use with any type of dynamoelectric machine having a rotor body that is subject to fretting or cracking along wedge loading surfaces that interface mating dovetail portions.

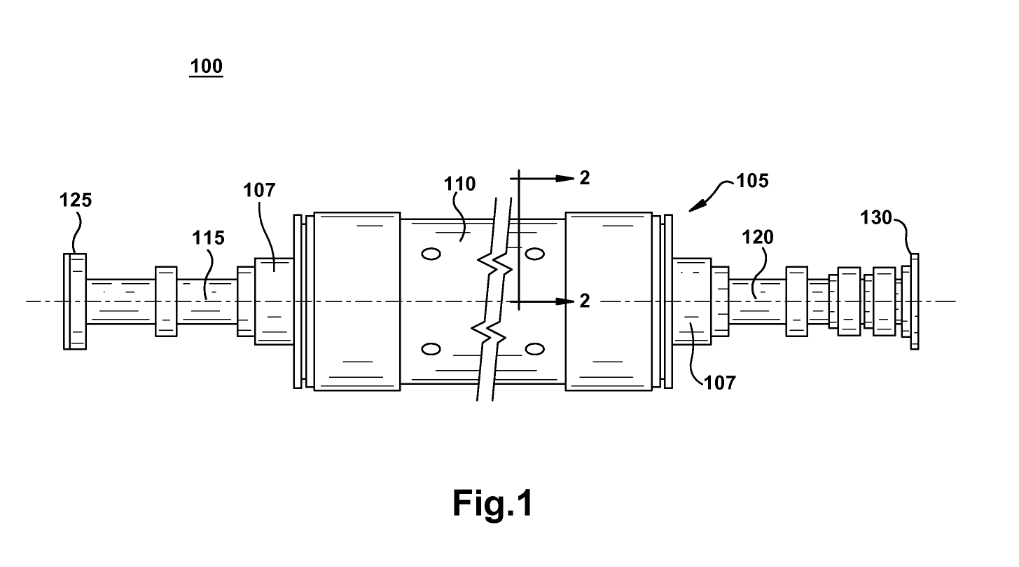

Referring to the drawings, FIG. 1 is a side-elevation view of a typical rotor 100 used for a dynamoelectric machine such as for example a generator. Since the description that follows relates to a generator, rotor 100 is referred to as a generator rotor. As shown in FIG. 1, generator rotor 100 includes a rotor body 105 that can be made of a ferrous metal material that is rotatably mounted on a central spindle 107 via a bearing assembly (not illustrated). Arranged circumferentially about the mid-section of rotor body 105 are a multiple of slots 110. In one embodiment, slots 110 which can be referred to as generator slots, are used for holding a multiple of field coils or coils that can be made of copper or aluminum. FIG. 1 further shows that generator rotor 100 includes elements such as rotor end shaft portions 115 and 120. Generator rotor 100 further includes couplings 125 and 130 for connection with a turbine such as a steam turbine or gas turbine. In one embodiment, couplings 125 and 130 can be used for connection with a gear reduction unit. In another embodiment, coupling 130 may be used to connect with an exciter (not shown).

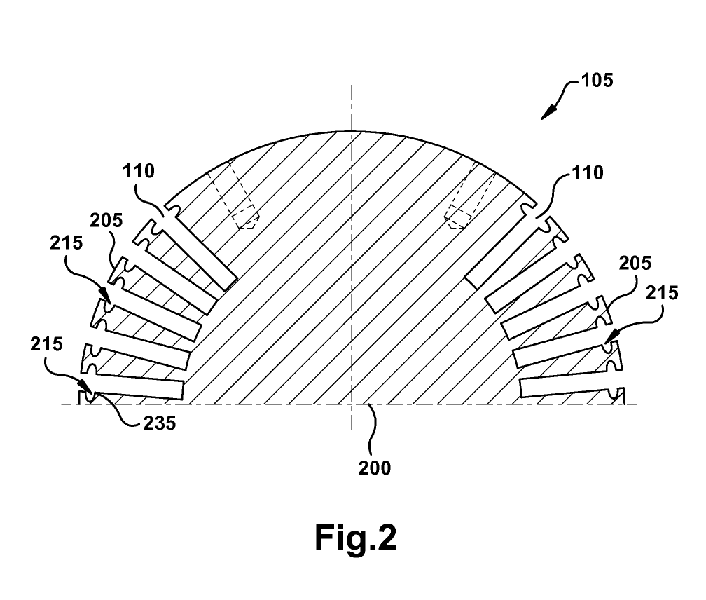

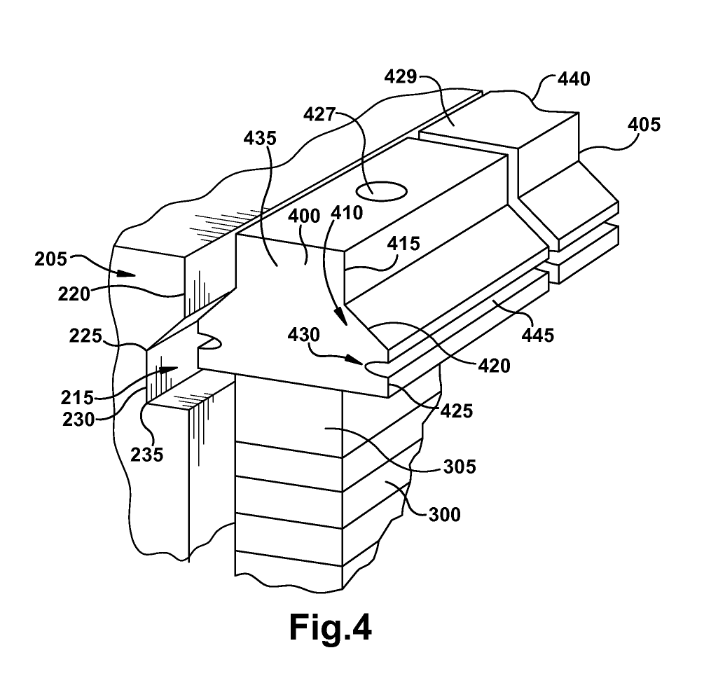

FIG. 2 is a partial cross-sectional view of rotor body 105 of rotor 100 taken along lines 2-2 of FIG. 1. In particular, FIG. 2 shows slots 110 radially-arranged about a rotor core 200 of rotor body 105. Although not clearly shown, slots 110 can extend axially along rotor body 105. As shown in FIG. 2, each of the radially-arranged slots 110 are separated by a rotor tooth 205 to form a multiple of rotor teeth arranged circumferentially about rotor body 105 with slots 110. Rotor teeth 205 are radially-arranged about rotor core 200 and extend axially along rotor body 105 separating each of slots 110. The arrangement of rotor teeth 205 with slots 110 defines a slot that extends a predetermined depth. Each slot 110 includes a dovetail 215 formed therein. Although not clearly shown in FIG. 2, but illustrated more evidently in FIG. 4, dovetail 215 of each slot 110 includes an entry surface 220, an inwardly tapered surface 225, an intermediate surface 230 and an outwardly tapered surface 235. FIG. 4 shows that inwardly tapered surface 225 extends inward towards rotor tooth 205 from entry surface 220, intermediate surface 230 extends downward from inwardly tapered surface 225, and outwardly tapered surface 235 extends outward towards a slot 110 (FIG. 2).

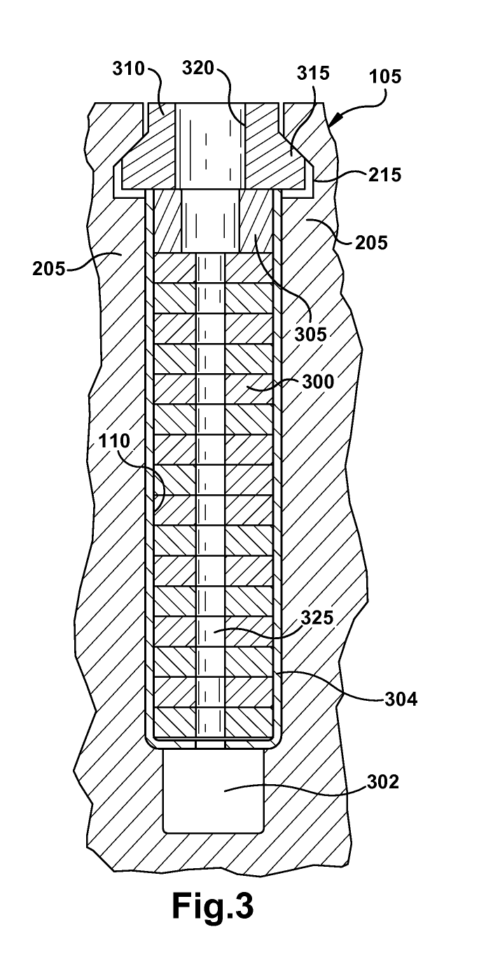

FIG. 3 is a cross-sectional view through slot 110 of rotor 100 such as those depicted in FIG. 2, that shows contents disposed therein. As noted above and illustrated in FIG. 2, slots 110 are radially-arranged about rotor core 200 of rotor body 105. Referring to FIG. 3, a slot 110 can contain in a radially outward sequence, insulated field coil turns or coil turns 300 disposed over a sub-slot 302, against slot insulation known as slot armor 304, a creepage block 305 disposed over the coil turns, and an axially aligned slot wedge 310. Each slot wedge 310 is mounted in a slot 110 capping the coil turns disposed therein. Each slot wedge 310 includes a wedge dovetail 315 that engages with a dovetail 215 formed in a slot 110 between rotor teeth 205. In particular, wedge dovetail 315 interfaces with dovetail 215 maintaining coil turns 300 and creepage block 305 in place while rotor 100 is spinning.

FIG. 3 also shows that slot wedge 310 may contain ventilation holes 320 (one shown) which are in general alignment with ventilation channels 325 (one shown) which pass through coil turns 300, as well as through creepage block 305.

Those skilled in the art will recognize that slot 110 can have more elements than what is illustrated in FIG. 3. For example, there could be turn insulation disposed between the coil turns 300 to insulate the coils and to prevent losses therefrom. Also, there could be amortisseur winding and its associative spring. In addition, slot armor 304 may have a different configuration than that illustrated in FIG. 3.

As mentioned above, rotor teeth 205 have the potential for fretting or cracking at surfaces where the teeth abut against slot wedges 310. In particular, cracks can occur at surfaces where wedge dovetail 315 interfaces with slot dovetail 215. Typically, the stress concentration that produces the most surface pressure to bring about cracking over a long period of time occurs at an edge of contact between where wedge dovetail 315 interfaces with slot dovetail 215. The cracking can also often happen at the end face of slot wedge 310. When cracking forms at these locations, the stress concentration is enough to spread cracks in both a radial direction and an axial direction from this edge of contact. Repairing cracks of this nature that form in rotor teeth 205 necessitate a labor intensive machining operation that may require rotor 100 to be taken offline for a period of time. As noted above, taking a rotor offline can be expensive and result in lost power generation production.

Various embodiments of the present invention as disclosed herein have overcome this fretting or cracking problem by providing a slot wedge with a groove that extends axially throughout the entire length of the wedge from a first wedge end face to a second wedge end face opposite therefrom. The axially extending groove creates a flexible region at the wedge where the slot dovetail interfaces with the wedge dovetail from the first wedge end face to the second wedge end face. This flexible region reduces the effects of the contact pressure at the interface by distributing stress concentrations away from the edges of interface between the slot dovetail and the wedge dovetail. Distributing stress concentrations away from the edges enables the reduction of the maximum stress that is placed on that area during normal operation of the rotor. As a result, fretting or cracking will be inhibited and in most cases eliminated.

FIG. 4 is a schematic of an enlarged, partial cross-sectional, perspective view showing a slot wedge 400 used to cap contents (e.g., coil turns 300 and creepage block 305) disposed in a slot 110 as depicted in FIG. 3 in relation to a rotor tooth 205 as depicted in FIG. 2, according to one embodiment of the present invention. For clarity in illustrating embodiments of the present invention, only one side of slot wedge 400 is described and labeled with reference numbers that point out specific features of the wedge. The other side of slot wedge 400, which is not labeled, would have corresponding features that are symmetrical with the referenced features.

As shown in FIG. 4, slot wedge 400 has a slot wedge side 405. Slot wedge side 405 has a wedge dovetail-shaped portion 410 that engages with a slot wall dovetail-shaped portion 215. As noted above, dovetail-shaped portion 215 includes an entry surface 220, an inwardly tapered surface 225, an intermediate surface 230, and an outwardly tapered surface 235. Inwardly tapered surface 225 extends inward towards rotor tooth 205 from entry surface 220, intermediate surface 230 extends downward from inwardly tapered surface 225, and outwardly tapered surface 235 extends outward towards slot 110.

Wedge dovetail-shaped portion 410 engages with dovetail-shaped portion 215 through features that mate with the geometry described for dovetail-shaped portion 215. As shown in FIG. 4, wedge dovetail-shaped portion 410 includes a slot wedge upper surface 415, a slot wedge outwardly extending surface 420, and a slot wedge lower surface 425. Wedge dovetail-shaped portion 410 mates with dovetail-shaped portion 215 by having slot wedge upper surface 415 engage with entry surface 220, slot wedge outwardly extending surface 420 engages with inwardly tapered surface 225, slot wedge lower surface 425 engages with intermediate surface 230, while a bottom area of wedge dovetail-shaped portion 410 sits on outwardly tapered surface 235 and a top portion of creepage block 305 disposed in slot 110. The intersection of the slot wedge outwardly extending surface 420 and the slot wedge lower surface 425 forms an edge of contact for slot wedge 400 and rotor tooth 205.

In one embodiment, as shown in FIG. 4, a radial hole 427 is located on a top portion 429 of slot wedge 400. Radial hole 427 functions to enable cooling gas flow through the coil (turns). In general, gas flows from the sub-slot (302, FIG. 3), through the coil 300 and out of the rotor (100, FIG. 1).

FIG. 4 shows that wedge dovetail-shaped portion 410 includes a groove 430 formed on a surface that interfaces with the dovetail 215. Groove 430 extends axially from a first wedge end face 435 to a second wedge end face 440 opposite therefrom. In one embodiment, groove 430 extends throughout the entire axial length of slot wedge 400 from first wedge end face 435 to second wedge end face 440.

Having groove 430 extend axially throughout the entire length of slot wedge 400 from first wedge end face 435 to second wedge end face 440 results in the creation of a flexible region 445 at an interface between wedge dovetail-shaped portion 410 and dovetail-shaped portion 215. For example, flexible region 445 would be created at the interface between slot wedge lower surface 425 and slot wedge outwardly extending surface 420, for an embodiment in which groove 430 is formed in the slot wedge lower surface. This flexible region would extend axially from first wedge end face 435 to second wedge end face 440. In this embodiment, flexible region 445 alleviates stress concentration at the edge of contact for slot wedge 400 and rotor tooth 205 that is formed from the intersection of slot wedge outwardly extending surface 420 and slot wedge lower surface 425. In this manner, slot wedge 400 has contact with a slot only at slot wedge outwardly extending surface 420 and inwardly tapered surface 225. There will be gaps in all other locations. As noted above, these edges of contact are locations that are known to be subject to the greatest stress concentration during the operation of a generator rotor, and over a long period of time are likely to develop fretting and cracking. The use of an axially extending groove 430 throughout the complete length of the wedge will alleviate the surface pressure at the interface between wedge dovetail-shaped portion 410 and dovetail-shaped portion 215. This reduces stress concentration at this interface, which reduces or eliminates the potential for fretting and cracking from occurring over long periods of operating a generator rotor.

While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the disclosure.

What is claimed is:

1. A rotor, comprising:
a plurality of radially-arranged slots each having a dovetail formed therein;
a plurality of coils disposed in each of the slots; and
a plurality of slot wedges each mounted in one of the slots capping the coils disposed therein, each slot wedge having a groove formed near a contacting surface that interfaces with a dovetail of one of the slots, the groove extending axially from a first wedge end face to a second wedge end face opposite therefrom.

2. The rotor according to claim 1, wherein each slot wedge includes a wedge dovetail that engages with a dovetail of one of the slots, the wedge dovetail of each slot wedge including a slot wedge upper surface, a slot wedge outwardly extending surface, and a slot wedge lower surface, the slot wedge lower surface including the axially extending groove.

3. The rotor according to claim 2, wherein the dovetail of each slot includes an entry surface, an inwardly tapered surface, and an intermediate surface, the entry surface engaging with a slot wedge upper surface of a slot wedge, the inwardly tapered surface engaging with a slot wedge outwardly extending surface of a slot wedge, and the intermediate surface engaging with a slot wedge lower surface of a slot wedge.

4. The rotor according to claim 3, wherein the axially extending groove creates a flexible region at an edge of contact formed from an intersection of the slot wedge outwardly extending surface and the slot wedge lower surface, the flexible region extending axially from the first wedge end face to the second wedge end face.

5. The rotor according to claim 4, wherein the flexible region alleviates stress concentration at the edge of contact.

6. The rotor according to claim 5, wherein the edge of contact forms the contact between the slot wedge and a rotor tooth.

7. A generator rotor, comprising:
a plurality of radially-arranged generator slots, each generator slot having a dovetail-shaped portion including an entry surface, an inwardly tapered surface, and an intermediate surface;
a plurality of field coil turns disposed in each of the generator slots; and
a plurality of slot wedges each mounted in one of the generator slots capping the field coil turns disposed therein, each side of each slot wedge having a wedge dovetail-shaped portion that engages with a dovetail-shaped portion of one of the slots, the wedge dovetail-shaped portion including a slot wedge upper surface, a slot wedge outwardly extending surface, and a slot wedge lower surface, the slot wedge lower surface having a groove extending axially throughout an entire length of the slot wedge from a first wedge end face to a second wedge end face, the slot wedge upper surface engaging with the entry surface, the slot wedge outwardly extending surface engaging with the inwardly tapered surface and the slot wedge lower surface engaging with the intermediate surface.

8. The generator rotor according to claim 7, wherein the axially extending groove creates a flexible region at an edge of contact from an intersection of the slot wedge outwardly extending surface and the slot wedge lower surface, the flexible region extending axially throughout the entire length of the slot wedge from the first wedge end face to the second wedge end face.

9. The generator rotor according to claim 8, wherein the flexible region alleviates surface pressure at the edge of contact.

10. The generator rotor according to claim 9, wherein the edge of contact forms the contact between the slot wedge and a rotor tooth.

11. A dynamoelectric machine, comprising:
a rotor including:
a plurality of radially-arranged slots, each slot having a dovetail-shaped portion including an entry surface, an inwardly tapered surface extending from the entry surface, and an intermediate surface extending from the inwardly tapered surface;
a plurality of coils disposed in each of the slots; and
a plurality of slot wedges each mounted in one of the slots capping the coils disposed therein, each side of each slot wedge having a wedge dovetail-shaped portion that engages with a dovetail-shaped portion of one of the slots, the wedge dovetail-shaped portion including a slot wedge upper surface, a slot wedge lower surface, and a slot wedge outwardly extending surface joining the slot wedge upper surface with the slot wedge lower surface, the slot wedge lower surface having a groove extending axially throughout an entire length of the slot wedge from a first wedge end face to a second wedge end face, the slot wedge upper surface engaging with the entry surface, the slot wedge outwardly extending surface engaging with the inwardly tapered surface and the slot wedge lower surface engaging with the intermediate surface.

12. The dynamoelectric machine according to claim 11, wherein the axially extending groove creates a flexible region at an edge of contact from an intersection of the slot wedge outwardly extending surface and the slot wedge lower surface, the flexible region extending axially throughout the entire length of the slot wedge from the first wedge end face to the second wedge end face.

13. The dynamoelectric machine according to claim 12, wherein the flexible region alleviates surface pressure at the edge of contact.

14. The dynamoelectric machine according to claim 13, wherein the edge of contact forms the contact between the slot wedge and a rotor tooth.
